(19) United States
(12) Patent Application Publication
(10) Pub. No.: US 2013/0201968 A1
(43) Pub. Date: Aug. 8, 2013

(54) RADIO COMMUNICATION SYSTEM, HIGH-POWER BASE STATION, LOW-POWER BASE STATION, AND COMMUNICATION CONTROL METHOD

(71) Applicants: Kazutaka Nakamura, Yokohama-shi (JP); Kenta Okino, Yokohama-shi (JP); Taku Nakayama, Yokohama-shi (JP)

(72) Inventors: Kazutaka Nakamura, Yokohama-shi (JP); Kenta Okino, Yokohama-shi (JP); Taku Nakayama, Yokohama-shi (JP)

(73) Assignee: KYOCERA CORPORATION, Kyoto (JP)

(21) Appl. No.: 13/641,399

(22) PCT Filed: Apr. 15, 2011
(86) PCT No.: PCT/JP2011/059440

§ 371 Date: Nov. 21, 2012

(30) Foreign Application Priority Data
Apr. 16, 2010 (JP) 2010-095547

(51) Int. Cl. H04W 72/04

(52) U.S. Cl. CPC H04W 72/048
USPC 370/336; 370/329

(57) ABSTRACT

A radio communication system 1 comprises a picocell base station PeNB placed within a communication area of a macrocell base station MeNB and has transmission output lower than the macrocell base station MeNB. A coverage of the picocell base station PeNB is expanded. A usable resource being a radio resource which a high-power base station is allowed to use as PDSCH is determined on the basis of a degree of expansion of coverage of a low-power base station.

### TECHNICAL FIELD

The present invention relates to a radio communication system, a high-power base station, a low-power base station, and a communication control method to which a heterogeneous network is applied.

### BACKGROUND ART

As the next generation systems to achieve higher-speed, larger-capacity communication than the 3rd and 3.5th generation cellular radio communication systems currently in use, there are LTE (Long Term Evolution) and LTE Advanced that is an enhanced version of LTE, which are standardized by the 3GPP (3rd Generation Partnership Project) being a standardization organization.

In a downlink of an LTE system (comprising LTE advanced), a radio base station transmits user data to a radio terminal by using a data transmission channel called a PDSCH (Physical Downlink Shared Channel). Note that a downlink refers to communication in a direction from a radio base station to a radio terminal whereas an uplink refers to communication in a direction from a radio terminal to a radio base station.

Meanwhile, as for LTE Advanced, there has been a plan to provide a heterogeneous network being a network in which low-power base stations (so-called picocell base stations, femtocell base stations, and relay nodes) are placed within the communication area of a high-power base station (so-called a macrocell base station). A heterogeneous network can distribute a load on a high-power base station to low-power base stations.

However, radio terminals are generally configured to be connected to the radio base station providing a radio signal with the highest received power among multiple radio base stations. Thus, in a heterogeneous network, there is a possibility that radio terminals are less likely to be connected to a low-power base station with low transmission output.

In view of such circumstances, techniques have been proposed which involve such control that radio terminals are connected to a low-power base station even when the received power from this low-power base station is not the highest, thereby expanding the coverage (the range of the communication area) of the low-power base station (see Non-patent Literature 1, for example).

### CITATION LIST

### Non-Patent Literature

Non-patent Literature 1: 3GPP R1-093433 “Importance of Serving Cell Selection in Heterogeneous Networks”, February 2010.

### SUMMARY OF THE INVENTION

Meanwhile, when there is overlap between radio resources used as data transmission channels of neighboring radio base stations, the data transmission channel of one of the radio base stations may receive interference from the data transmission channel of the other radio base station, and whereby the radio terminal may possibly fail to receive user data through the data transmission channel of the one radio base station.

The above problem is even worse particularly in the case of the techniques that expand the coverage of a low-power base station in a heterogeneous network, because the data transmission channel of the low-power base station is highly likely to receive great interference from the data transmission channel of a high-power base station.

In this respect, an objective of the present invention is to provide a radio communication system, a high-power base station, a low-power base station, and a communication control method which can avoid the interference between the radio base stations in the heterogeneous network, and thereby improve the throughput of the whole system.

The present invention has the following features to solve the problem described above.

A feature of a radio communication system of the present invention is summarized as follows. A radio communication system (radio communication system 1) comprises: a high-power base station (macrocell base station MeNB); and a low-power base station (picocell base station PeNB) placed within a communication area of the high-power base station and having transmission output lower than the high-power base station, the radio communication system further comprising: a determining unit (usable-resource determining unit 123 or to-be-allocated radio-resource determining unit 224) configured to determine a usable resource being a radio resource which the high-power base station is allowed to use as a particular downlink channel (e.g., PDSCH); and an allocating unit (resource allocating unit 124) configured to allocate a radio resource to a radio terminal connected to the high-power base station, out of the usable resource determined by the determining unit, wherein the determining unit determines the usable resource in a case of expanding coverage of the low-power base station. In this respect, a particular downlink channel is, for example, a downlink data transmission channel (PDSCH in the LTE system). However, a particular downlink channel is not limited to such a data communication channel, but may be a downlink control information transmission channel (PDCCH in the LTE system) or the like. In addition, a low-power base station is, for example, a picocell base station or a femtocell base station. However, a low-power base station is not limited to a picocell base station or a femtocell base station, but may be a relay node or the like.

In the radio communication system according to the above feature, the radio resource which can be used as the particular downlink channel can be limited in the case where the coverage of the low-power base station is expanded (e.g., in the case where there is a possibility of large interference). Accordingly, by allowing the low-power base station to use the radio resource which the high-power base station cannot use, it is possible to avoid the interference from the high-power base station and thereby improve the throughput of the low-power base station.

Another feature of the radio communication system of the present invention is summarized as follows. In the radio communication system according to the feature above, the determining unit determines the usable resource in such a way that the usable resource decreases as a degree of the expansion of the coverage of the low-power base station increases.

Another feature of the radio communication system of the present invention is summarized as follows. In the radio communication system according to the feature above, the determining unit determines the usable resource in such a way that when the coverage of the low-power base station is expanded, the usable resource is smaller than the usable resource before the expansion of the coverage of the low-power base station.

Another feature of the radio communication system of the present invention is summarized as follows. In the radio communication system according to the feature above, the determining unit determines the usable resource in such a way as to avoid a radio resource that is to be allocated to a radio terminal having reception quality deteriorated due to the coverage expansion, among radio terminals connected to the low-power base station.

Another feature of the radio communication system of the present invention is summarized as follows. The radio communication system according the feature above further comprises a selecting unit (connecting-destination selecting unit 121, connecting-destination selecting unit 221) configured to select a base station with the highest reception quality value as a connecting destination of a radio terminal, on the basis of: a first reception quality value (RSRP_{MeNB}) indicative of a reception quality of a radio signal which the radio terminal receives from the high-power base station; a second reception quality value (RSRP_{PeNB}) indicative of the reception quality of a radio signal which the radio terminal receives from the low-power base station; and a correction value (bias value) for correcting the second reception quality value to a higher value, wherein the correction value is indicative of a degree of the expansion of the coverage of the low-power base station, and the determining unit determines the usable resource on the basis of the correction value.

Another feature of the radio communication system of the present invention is summarized as follows. In the radio communication system according to the feature above, the particular downlink channel is a data transmission channel for transmitting user data to a radio terminal.

Another feature of the radio communication system of the present invention is summarized as follows. In the radio communication system according to the feature above, the usable resource is a frequency band being at least part of an entire frequency band (all resource blocks) of a downlink.

Another feature of the radio communication system of the present invention is summarized as follows. In the radio communication system according to the feature above, the usable resource is a time range being at least part of a communication time frame (subframe or radio frame) of a downlink.

A feature of a high-power base station of the present invention is summarized as follows. A high-power base station comprises: a determining unit (usable-resource determining unit 123) configured to determine a usable resource being a radio resource which the high-power base station is allowed to use as a particular downlink channel (e.g., PDSCH), on the basis of a degree of expansion of coverage of a low-power base station (e.g., picocell base station PeNB) placed within a communication area of the high-power base station and having transmission output lower than the high-power base station; and an allocating unit (resource allocating unit 124) configured to allocate a radio resource to a radio terminal connected to the high-power base station, out of the usable resource determined by the determining unit.

A feature of a low-power base station of the present invention is summarized as follows. A low-power base station (e.g., picocell base station PeNB) placed within a communication area of a high-power base station (macrocell base station MeNB) and having transmission output lower than the high-power base station, comprises: a to-be-allocated radio-resource determining unit (to-be-allocated radio-resource determining unit 224) configured to, in a case of expanding coverage of the low-power base station, determine a radio resource that is to be allocated to a radio terminal having reception quality deteriorated due to the coverage expansion, among radio terminals connected to the low-power base station; and a transmitter (X2-interface communication unit 240) configured to transmit information indicative of the to-be-allocated radio resource determined by the to-be-allocated radio-resource determining unit to the high-power base station.

A feature of a communication control method of the present invention is summarized as follows. A communication control method comprises the steps of: determining a usable resource being a radio resource which a high-power base station is allowed to use as a particular downlink channel, on the basis of a degree of expansion of coverage of a low-power base station placed within a communication area of the high-power base station and having transmission output lower than the high-power base station; and allocating a radio resource to a radio terminal connected to the high-power base station, out of the usable resource determined in the determining step.

Another feature of a communication control method of the present invention is summarized as follows. A communication control method comprises the steps of: in a case of expanding coverage of a low-power base station placed within a communication area of a high-power base station and having transmission output lower than the high-power base station, determining a radio resource that is to be allocated to a radio terminal having reception quality deteriorated due to the coverage expansion, among radio terminals connected to the low-power base station; and transmitting information indicative of the to-be-allocated radio resource determined in the determining step from the low-power base station to the high-power base station.

A feature of a communication control method of the present invention is summarized as follows. A communication control method comprises the steps of: determining a usable resource being a radio resource which a high-power base station is allowed to use as a particular downlink channel, on the basis of a degree of expansion of coverage of a low-power base station placed within a communication area of the high-power base station and having transmission output lower than the high-power base station; and transmitting information indicative of the usable resource determined in the determining step from the high-power base station to the low-power base station.

The present invention can provide a radio communication system, a high-power base station, a low-power base station, and a communication control method which can avoid the interference between the radio base stations in the heterogeneous network, and thereby improve the throughput of the whole system.

### BRIEF DESCRIPTION OF THE DRAWINGS

FIG. 1 is a diagram for describing a summary of an LTE system according to the first embodiment and the second embodiment.

FIG. 2 is a frame configuration diagram showing the configuration of a radio frame in a case of using an FDD scheme.

FIG. 3 is a schematic configuration diagram of a radio communication system according to the first embodiment.

FIG. 4 is a diagram for describing the interference control according to the first embodiment and the second embodiment.

FIG. 5 is a diagram showing a ratio of radio terminals each connected to macrocell base stations and picocell base stations within a macrocell.

FIG. 6 is a block diagram showing the configuration of the macrocell base station according to the first embodiment.

FIG. 7 is a block diagram showing the configuration of the picocell base station according to the first embodiment.

FIG. 8 is an operation sequence diagram showing operations of the radio communication system according to the first embodiment.

FIG. 9 is a block diagram showing the configuration of the macrocell base station according to the second embodiment.

FIG. 10 is a block diagram showing the configuration of the picocell base station according to the second embodiment.

FIG. 11 is an operation sequence diagram showing operations of the radio communication system according to the second embodiment.

FIG. 12 is a diagram for describing the case of time-dividing the PDSCH resource.

FIG. 13 is a diagram for describing another case of time-dividing the PDSCH resource.

### DESCRIPTION OF THE EMBODIMENTS

The first embodiment, the second embodiment, and other embodiments of the present invention will be described. The same or similar reference numerals are applied to the same or similar parts in the drawings of each embodiment.

### [Summary of LTE System]

Before describing the first embodiment and the second embodiment, a summary of an LTE system will be described in relation to a content related to the present invention.

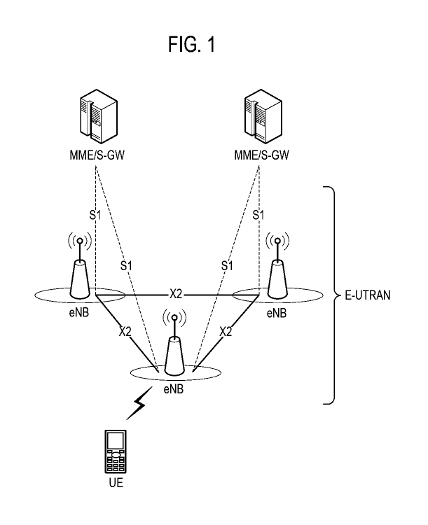

FIG. 1 is a diagram for describing a summary of an LTE system. As shown in FIG. 1, multiple radio base stations eNB constitute an E-UTRAN (Evolved-UMTS Terrestrial Radio Access Network). Each of the multiple radio base station eNB forms a cell as a communication area to provide a service to a radio terminal UE.

The radio terminal UE is radio communication equipment a user possesses and is also called user equipment. The radio terminal UE is connected to the radio base station eNB with the highest reference signal received power (RSRP) among the multiple radio base stations eNB. However, it is possible to use a different reception quality index such as SNR (Signal to Noise ratio) instead of RSRP.

The radio base stations eNB are capable of communicating with each other through an X2 interface which is a logical communication channel providing inter-base-station communication. The multiple radio base stations eNB are each capable of communicating with an EPC (EvolvedPacketCore), or an MME (Mobility Management Entity) and an S-GW (Serving Gateway) to be specific, through an S1 interface.

Radio communication between each radio base station eNB and the radio terminal UE employs an OFDMA (Orthogonal Frequency Division Multiple Access) scheme as a multiplexing scheme in the downlink and an SC-FDMA (Single-Carrier Frequency Division Multiple Access) scheme as a multiplexing scheme in the uplink, and also employs an FDD (Frequency Division Duplex) scheme or a TDD (Time division Duplex) scheme as a duplex scheme.

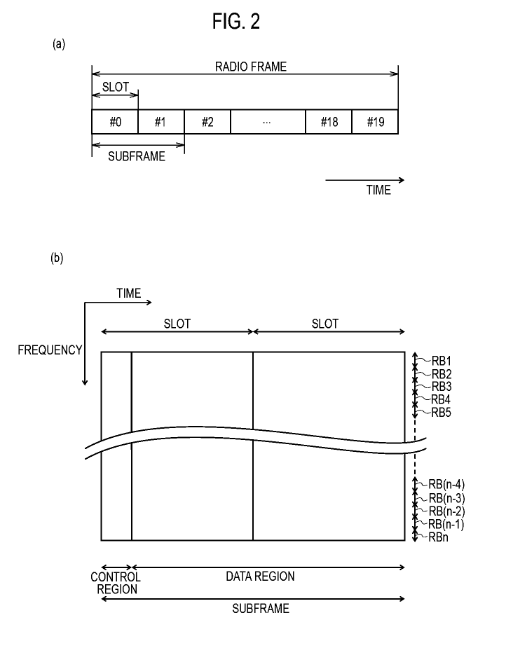

Part (a) of FIG. 2 is a frame configuration diagram showing the configuration of a downlink radio frame in a case of using an FDD scheme. Part (b) of FIG. 2 is a frame configuration diagram showing a downlink subframe.

As shown in Part (a) FIG. 2, the downlink radio frame is formed of 10 downlink subframes, and each downlink subframe is formed of 2 downlink slots. The length of each downlink subframe is 1 ms, and the length of each downlink slot is 0.5 ms. Moreover, as shown in Part (b) of FIG. 2, each downlink slot is formed of multiple resource blocks (RB) in the time axis direction and multiple RBs in the frequency axis direction (frequency domain). In a case of normal cyclic prefix, each RB contains 7 OFDM symbols in the time axis direction and 12 subcarriers in the frequency axis direction.

As shown in Part (b) of FIG. 2, the downlink subframe contains two continuous downlink slots. In the downlink subframe, a section with maximum three OFDM symbols from the head of the first downlink slot is a control region which forms a radio resource to be used as a PDCCH (Physical Downlink Control Channel) for transmitting control information. The control information corresponds to scheduling information on the uplink and the downlink (i.e., information on allocated radio resources) and the like.

A section with the remaining OFDM symbols in the downlink subframe is a data region which forms a radio resource to be used as a PDSCH (Physical Downlink Shared Channel) for transmitting user data. The radio terminal UE can specify the user data transmitted through the PDSCH by decoding the control information transmitted through the PDSCH.

### First Embodiment

Next, the first embodiment of the present invention will be described. The first embodiment will be described by taking, as an example, a heterogeneous network configuration designed such that picocell base stations PeNB serving as low-power base stations (low-output base stations) are placed within the communication area (macrocell) of a macrocell base station MeNB serving as a high-power base station (high-output base station).

The first embodiment will be described below through (1) Configuration of Radio Communication System, (2) Interference Control, (3) Configuration of Macrocell Base Station, (4) Configuration of Picocell Base Station, (5) Operations of Radio Communication System, and (6) Advantageous Effects of First Embodiment in this order mentioned.

### (1) Configuration of Radio Communication System

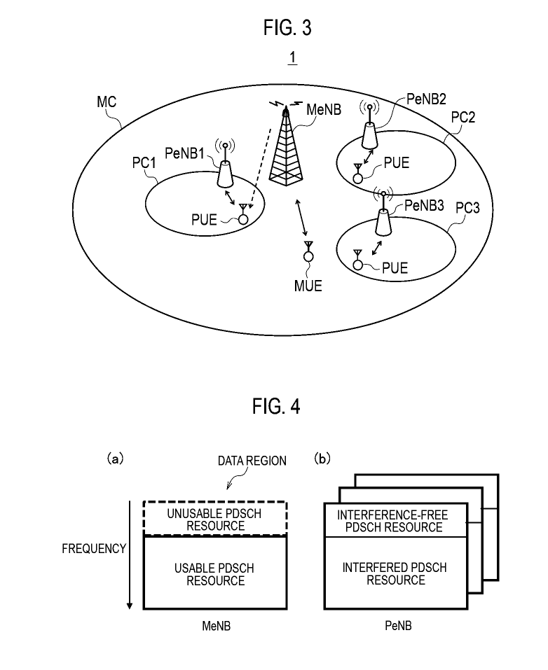

FIG. 3 is a schematic configuration diagram of a radio communication system 1 according to the first embodiment.

As shown in FIG. 3, the radio communication system 1 comprises: a macrocell base station MeNB; a radio terminal MUE which is connected to the macrocell base station MeNB; picocell base stations PeNB1 to PeNB3 which are placed within a macrocell MC formed by the macrocell base station MeNB and are located adjacent to the macrocell base station MeNB; and radio terminals PUE which are connected to the picocell base stations PeNB within picocells PC formed by the picocell base stations PeNB1 to PeNB3. In the following, the picocell base stations PeNB1 to PeNB3 will be simply called the picocell base station(s) PeNB when they do not particularly need to be distinguished from one another. The macrocell base station MeNB and the picocell base stations PeNB use the same frequency band. Note that the picocell PC formed by each picocell base station PeNB will be called a “hot zone” below.

Each picocell base station PeNB (also called a “hot zone node”) is a low-power base station lower than the macrocell base station MeNB in transmission output and is placed within a high-traffic zone inside the macrocell. In a heterogeneous network, the transmission output of the picocell base station PeNB is low. Thus, the coverage of the picocell base station PeNB may possibly be small in a case of employing a highest received power basis (hereinafter, RP basis) being a connecting-destination selection basis in which the radio terminal UE selects and is connected to the radio base station eNB with the highest RSRP. The coverage of the picocell base station PeNB is extremely small particularly in a situation where the location of the picocell base station PeNB is close to the macrocell base station MeNB, thereby making it impossible to effectively utilize the picocell base station PeNB.

The following method can be used as a method that allows expansion of the coverage of the picocell base station PeNB without increasing the transmission output of the picocell base station PeNB. Specifically, the method is such that when the radio terminal UE can receive a radio signal from each of the macrocell base station MeNB and the picocell base station PeNB, the RSRP of the picocell base station PeNB and the RSRP of the macrocell base station MeNB are compared with each other with a bias value (bias) being added to the RSRP of the picocell base station PeNB. Biasing the RSRP of the picocell base station PeNB (i.e., adding a bias value to the RSRP of the picocell base station PeNB) increases the possibility of the biased RSRP becoming greater than the RSRP of the macrocell base station MeNB. Consequently, the picocell base station PeNB becomes more likely to be selected as the connecting destination, which in turn expands the coverage of the picocell base station PeNB. This connecting-destination selection basis is called a range expansion basis (hereinafter, RE basis).

The RE-basis bias value takes a large value for those picocell base stations PeNB being close in distance to the macrocell base station MeNB (or having a small path loss) and takes a small value for those picocell base stations PeNB being far in distance from the macrocell base station MeNB (or having a large path loss), for example. Meanwhile, the macrocell base station MeNB or each picocell base station PeNB is capable of determining the RE-basis bias value by measuring the above-mentioned distance or path loss by means of a publicly known technique. Further, when determining the bias value, the macrocell base station MeNB or each picocell base station PeNB may determine the bias value by taking into account the distribution of the terminals inside the macrocell and the traffic load on the picocell base station PeNB.

The first embodiment assumes that the macrocell base station MeNB determines each RE-basis bias value and that the coverage of each picocell base station PeNB has been expanded according to the RE basis. Note that the subject that selects a connecting destination of the radio terminal UE is the radio terminal UE when the radio terminal UE is waiting (idle state), and is the radio base station eNB being the connecting destination when the radio terminal UE is performing communication (active state). During the active state, the radio terminal UE periodically reports the measured value of the RSRP to the radio base station being the connecting destination, which in turn allows the radio base station eNB being the connection destination to select the next connecting destination of the radio terminal UE and to perform handover of the radio terminal UE to the next connecting destination.

The macrocell base station MeNB transmit user data to the radio terminal MUE by using a PDSCH. Each picocell base station PeNB transmit user data to its radio terminal PUE by using a PDSCH. In a case where the frequency bands of these PDSCHs overlap each other, the PDSCHs of the macrocell base station MeNB and the picocell base station PeNB interfere with each other.

In the state where the coverage of the picocell base station PeNB is expanded, the radio terminal PUE connected to the picocell base station PeNB may receive higher power from the macrocell base station MeNB than from the picocell base station PeNB in some cases. In this case, the PDSCH of the picocell base station PeNB receives great interference from the PDSCH of the macrocell base station MeNB, thereby making it impossible for the radio terminal PUE to receive (decode) user data.

### (2) Interference Control

Suppose that in the downlink of the heterogeneous network, a bias is added according to the RE basis so that the coverage can be expanded to be wider than a hot zone created by the RP basis. In this case, the difference in transmission power between the macrocell base station MeNB and the picocell base station PeNB makes the interference power greater than desired signal power.

This results in a radio terminal UE with inappropriate SINR being set in the hot zone. Such a radio terminal UE receives extremely strong interference from the macrocell base station MeNB, which basically has high transmission power, so that the SINR becomes extremely low.

In this respect, the following interference control is performed in the first embodiment. FIG. 4 is a diagram for describing the interference control according to the first embodiment.

As shown in Part (a) of FIG. 4, the PDSCH resource of the macrocell base station MeNB (corresponding to the data region shown in Part (b) of FIG. 2) is frequency-divided. Only some of the divided PDSCH resources are used while the remaining portion is left unused so that those radio terminals PUE with low SINR in hot zones can use the unused portion. The PDSCH resource which the macrocell base station MeNB can use will be called the “usable PDSCH resource” when necessary, and the PDSCH resource the macrocell base station MeNB cannot use will be called the “unusable PDSCH resource” when necessary. In the first embodiment, the usable PDSCH resource corresponds to at least some resource blocks of all the downlink resource blocks, and the unusable PDSCH resource corresponds to the remaining resource blocks of all the downlink resource blocks excluding the some resource blocks.

As shown in Part (b) of FIG. 4, since a radio resource corresponding to the unusable PDSCH resource receives no interference from the macrocell base station MeNB, each picocell base station PeNB allocates such an interference-free PDSCH resource to its radio terminal PUE with low SINR. Specifically, each radio terminal PUE periodically feeds back the result of reception quality measurement as channel quality information (CQI) to its picocell base station PeNB. Then, when the CQI corresponding to the interference-free PDSCH resource is good, the picocell base station PeNB can allocate the interference-free PDSCH resource to the radio terminal PUE in priority.

Alternatively, the unusable PDSCH resource may be notified to each picocell base station PeNB from the macrocell base station MeNB so that the picocell base station PeNB can figure out its interference-free PDSCH resource. In this case, the picocell base station PeNB can allocate the interference-free PDSCH resource to the radio terminal PUE in priority, without waiting until the CQI corresponding to the interference-free PDSCH resource becomes good. The first embodiment assumes that the macrocell base station MeNB notifies each picocell base station PeNB of the unusable PDSCH resource.

The above interference control based on frequency division can avoid interference with a hot zone but at the same time reduces the PDSCH resource allocatable to the radio terminal MUE connected to the macrocell base station MeNB. Then, in order to achieve characteristic improvement through the expansion of the coverage of a hot zone, the effect of the characteristic improvement offered by the load distribution needs to be greater than the loss attributable to the reduction of the usable resource caused by the frequency division.

In this respect, in the first embodiment, the amount or ratio of the usable PDSCH resource is determined as shown in FIG. 4 on the basis of the RE-basis bias value which indicates the degree of the expansion of the coverage of the picocell base station PeNB. Here, in a case where multiple picocell base stations PeNB are placed within the same macrocell as in the example of FIG. 1, used is the average of the bias values of the picocell base stations PeNB. Although the PDSCH resource can be divided in various ways, it is divided according to the resolution of the CQI to be fed back, in consideration of the specifications of LTE. Specifically, the frequency band of each of the usable PDSCH resource and the unusable PDSCH resource is an integral multiple of a frequency unit based on which the radio terminal UE measures the reception quality (channel quality). The frequency unit is called the subband.

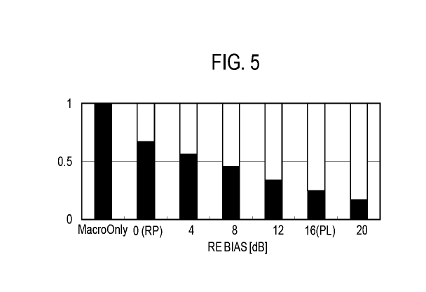

FIG. 5 is a diagram showing an example of the ratio of the radio terminals UE connected to the macrocell base station MeNB and the radio terminals UE connected to the picocell base stations PeNB1 to PeNB3 within the macrocell.

As shown in FIG. 5, it can be seen that the ratio of the radio terminals UE connected to the picocell base stations PeNB increases as the RE-basis bias value increases. Thus, the usable PDSCH resource of the macrocell base station MeNB is decreased as the RE-basis bias value is increased, and the usable PDSCH resource of the macrocell base station MeNB is increased as the RE-basis bias value is decreased. Moreover, in a case where the RE-basis bias value is updated as appropriate, it is desirable to re-set the usable PDSCH resource of the macrocell base station MeNB in accordance with the update of the bias value.

### (3) Configuration of Macrocell Base Station

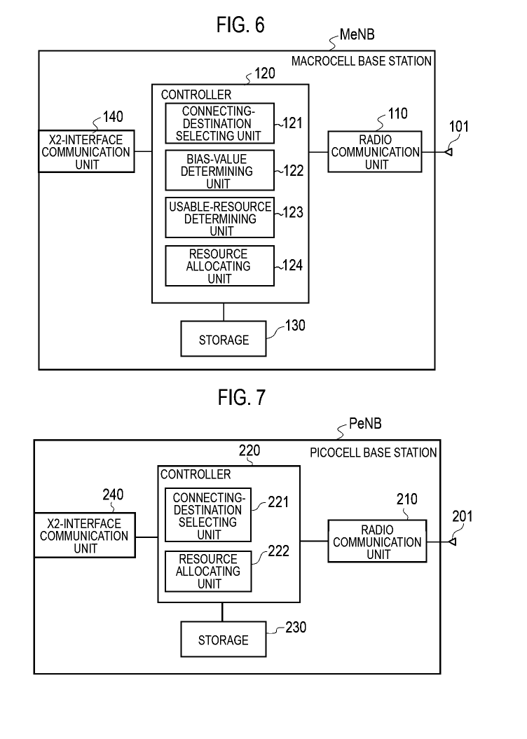

Next, the configuration of the macrocell base station MeNB will be described. FIG. 6 is a block diagram showing the configuration of the macrocell base station MeNB according to the first embodiment.

As shown in FIG. 6, the macrocell base station MeNB comprises an antenna unit 101, a radio communication unit 110, a controller 120, a storage 130, and an X2-interface communication unit 140.

The radio communication unit 110 is formed by using a radio frequency (RF) circuit, a base band (BB) circuit, and the like, for example, and transmits and receive radio signals to and from the radio terminal PUE through the antenna unit 101. The radio communication unit 110 is also configured to modulate signals it transmits and to demodulate signals it receives.

The controller 120 is formed by using a CPU, for example, and controls various functions provided in the macrocell base station MeNB. The storage 130 is formed by using a memory, for example, and stores various types of information used for control of the macrocell base station MeNB and other purposes. The X2-interface communication unit 140 performs inter-base-station communication with the other radio base stations by using the X2 interface.

The controller 120 comprises a connecting-destination selecting unit 121, a bias-value determining unit 122, a usable-resource determining unit 123, and a resource allocating unit 124.

The connecting-destination selecting unit 121 selects a radio base station as the next connecting destination of the radio terminal MUE on the basis of RSRP information reported from the radio terminal MUE (i.e., measurement report). In a case where the radio terminal MUE receives a reference signal from each of the macrocell base station MeNB and the picocell base station PeNB, the connecting-destination selecting unit 121 compares RSRP_{MeNB} of the macrocell base station MeNB and RSRP_{PeNB} of the picocell base station PeNB with a bias being added to the RSRP_{PeNB}. In a case where the biased RSRP_{PeNB} is greater than the RSRP_{MeNB}, the connecting-destination selecting unit 121 performs such handover control that the connecting destination of the radio terminal MUE will be switched to the picocell base station PeNB.

The bias-value determining unit 122 determines the RE-basis bias value for each picocell base station PeNB. Note that the present invention is not limited to the case of the bias-value determining unit 122 determining the RE-basis bias value for each picocell base station PeNB. The RE-basis bias value may be stored in the storage 130 in advance.

The usable-resource determining unit 123 determines the usable PDSCH resource on the basis of the RE-basis bias value. Specifically, the usable-resource determining unit 123 decreases the usable PDSCH resource of the macrocell base station MeNB as the RE-basis bias value increases, and increases the usable PDSCH resource of the macrocell base station MeNB as the RE-basis bias value decreases. Here, the RE-basis bias value can be the average of the bias values of the picocell base stations PeNB1 to PeNB3. In the case where the RE-basis bias value is updated as appropriate, it is desirable that the usable-resource determining unit 123 re-sets the usable PDSCH resource of the macrocell base station MeNB in accordance with the update of the bias value.

The resource allocating unit 124 allocates a radio resource (resource blocks) to the radio terminal MUE out of the usable PDSCH resource determined by the usable-resource determining unit 123. For example, the resource allocating unit 124 allocates a radio resource (resource blocks) to the radio terminal MUE out of the usable PDSCH resource on the basis of the CQI fed back from the radio terminal MUE by use of a scheduling algorithm such as proportional fairness (PF).

### (4) Configuration of Picocell Base Station

Next, the configuration of each picocell base station PeNB will be described. FIG. 7 is a block diagram showing the configuration of the picocell base station PeNB according to the first embodiment.

As shown in FIG. 7, each picocell base station PeNB comprises an antenna unit 201, a radio communication unit 210, a controller 220, a storage 230, and an X2-interface communication unit 240.

The radio communication unit 110 is formed by using a radio frequency (RF) circuit, a base band (BB) circuit, and the like, for example, and transmits and receive radio signals to and from the radio terminal PUE through the antenna unit 201. The radio communication unit 210 is also configured to modulate signals it transmits and to demodulate signals it receives.

The controller 220 is formed by using a CPU, for example, and controls various functions provided in the picocell base station PeNB. The storage 230 is formed by using a memory, for example, and stores various types of information used for control of the picocell base station PeNB and other purposes. The X2-interface communication unit 240 performs inter-base-station communication with the other radio base stations by using the X2 interface.

The controller 220 comprises a connecting-destination selecting unit 221 and a resource allocating unit 222.

The connecting-destination selecting unit 221 selects a radio base station as the next connecting destination of the radio terminal PUE on the basis of the RSRP reported from the radio terminal PUE connected to the picocell base station PeNB. In a case where the radio terminal PUE receives a reference signal from each of the macrocell base station MeNB and the picocell base station PeNB, the connecting-destination selecting unit 221 compares the RSRP_{MeNB} of the macrocell base station MeNB and the RSRP_{PeNB} of the picocell base station PeNB with a bias being added to the RSRP_{PeNB}. In a case where the biased RSRP_{PeNB} is lower than the RSRP_{MeNB}, the connecting-destination selecting unit 221 performs such handover control that the connecting destination of the radio terminal PUE will be switched to the macrocell base station MeNB.

The resource allocating unit 222 allocates a radio resource (resource blocks) to the radio terminal PUE. For example, the resource allocating unit 222 allocates a radio resource (resource blocks) to the radio terminal MUE out of a PDSCH resource on the basis of the CQI fed back from the radio terminal PUE by use of a scheduling algorithm such as proportional fairness (PF). In a case where the unusable PDSCH resource is notified from the macrocell base station MeNB, the resource allocating unit 222 allocates the interference-free PDSCH resource (see FIG. 4) corresponding to the unusable PDSCH resource to the radio terminal PUE in priority, without waiting until the CQI corresponding to the interference-free PDSCH resource becomes good.

### (5) Operations of Radio Communication System

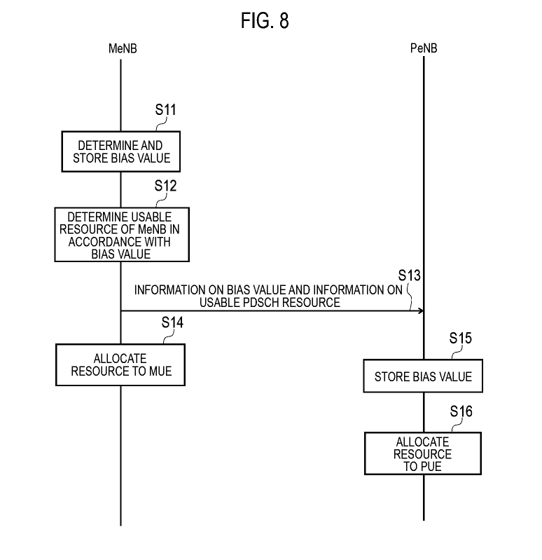

FIG. 8 is an operation sequence diagram showing operations of the radio communication system 1 according to the first embodiment.

In step S11, the bias-value determining unit 122 of the macrocell base station MeNB determines the RE-basis bias value for each picocell base station PeNB and stores the bias value in the storage 130. The bias value stored in the storage 130 will then be referred to by the connecting-destination selecting unit 121.

In step S12, the usable-resource determining unit 123 of the macrocell base station MeNB determines the usable PDSCH resource and unusable PDSCH resource of the macrocell base station MeNB on the basis of the RE-basis bias value.

In step S13, the X2-interface communication unit 140 of the macrocell base station MeNB transmits information indicative of the bias value determined by the bias-value determining unit 122 and information indicative of the unusable PDSCH resource determined by the usable-resource determining unit 123 to each picocell base station PeNB. The X2-interface communication unit 240 of the picocell base station PeNB receives the information indicative of the bias value and the information indicative of the unusable PDSCH resource.

In step S14, the resource allocating unit 124 of the macrocell base station MeNB allocates a radio resource (resource blocks) to the radio terminal MUE out of the usable PDSCH resource determined by the usable-resource determining unit 123.

In step S15, the storage 230 of the picocell base station PeNB stores the information indicative of the bias value received by the X2-interface communication unit 240. The bias value will then be referred to by the connecting-destination selecting unit 221.

In step S16, the resource allocating unit 222 of the picocell base station PeNB allocates a radio resource (resource blocks) to its radio terminal PUE. The resource allocating unit 222 allocates the interference-free PDSCH resource (see FIG. 4) corresponding to the unusable PDSCH resource to the radio terminal PUE with low SINR in priority on the basis of the information indicative of the unusable PDSCH resource received by the X2-interface communication unit 240.

### (6) Advantageous Effects of First Embodiment

As described above, the radio communication system 1 limits the radio resource which the macrocell base station MeNB can use as its PDSCH. By using the PDSCH resource which the macrocell base station MeNB cannot use as its PDSCH, each picocell base station PeNB can avoid interference from the macrocell base station MeNB. Accordingly, it is possible to improve the throughput of the picocell base station PeNB.

Moreover, by determining the radio resource which the macrocell base station MeNB can use as its PDSCH on the basis of the RE-basis bias value, the PDSCH resource which the macrocell base station MeNB cannot use as its PDSCH can be prevented from being becoming too large. Accordingly, it is possible to improve the throughput of each picocell base station PeNB and, at the same time, to prevent decrease in the throughput of the macrocell base station MeNB, and thereby improve the throughput of the whole system.

In the first embodiment, the usable-resource determining unit 123 determines the radio resource which the macrocell base station MeNB can use as its PDSCH on the basis of the average of the bias values of the multiple picocell base stations PeNB. Accordingly, it is possible to handle the case where the multiple picocell base stations PeNB are placed within the communication area of the macrocell base station MeNB.

### Second Embodiment

In the second embodiment, each picocell base station PeNB transmits information for determining the usable PDSCH resource of the macrocell base station MeNB to the macrocell base station MeNB. In the following, differences from the first embodiment will be described, and overlapping description will be omitted.

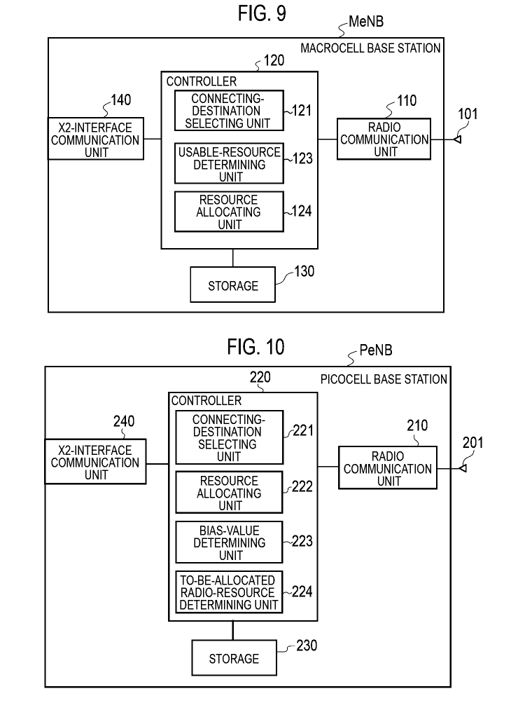

FIG. 9 is a block diagram showing the configuration of the macrocell base station MeNB according to the second embodiment. As shown in FIG. 9, the macrocell base station MeNB according to the second embodiment does not comprise the bias-value determining unit 122 described in the first embodiment.

FIG. 10 is a block diagram showing the configuration of each picocell base station PeNB according to the second embodiment. As shown in FIG. 10, each picocell base station PeNB according to the second embodiment comprises a bias-value determining unit 223 and a to-be-allocated radio-resource determining unit 224. The bias-value determining unit 223 determines the RE-basis bias value. The method of determining the bias value is the same as that in the first embodiment. The to-be-allocated radio-resource determining unit 224 is configured to, in a case where the coverage of the picocell base station PeNB is expanded according to the RE basis, determine the to-be-allocated radio resource of a radio terminal PUE having reception quality (e.g., SINR) deteriorated due to the coverage expansion, among the radio terminals PUE connected to the picocell base station PeNB. The to-be-allocated radio resource is not a currently allocated radio resource but is a radio resource to be allocated later in time (e.g., several subframes later).

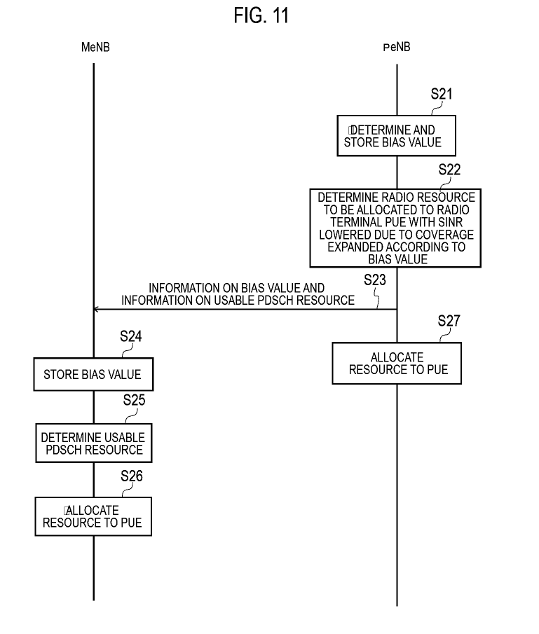

FIG. 11 is an operation sequence diagram showing operations of the radio communication system 1 according to the second embodiment. The example of FIG. 11 shows the sequence of operations performed between one picocell base station PeNB and the macrocell base station MeNB.

In step S21, the bias-value determining unit 223 of the picocell base station PeNB determines the RE-basis bias value and stores the bias value in the storage 230. The bias value stored in the storage 230 will then be referred to by the connecting-destination selecting unit 221.

In step S22, in a case where the coverage of the picocell base station PeNB is expanded according to the RE basis, the to-be-allocated radio-resource determining unit 224 of the picocell base station PeNB determines the to-be-allocated radio resource of a radio terminal PUE having reception quality (e.g., SINR) deteriorated due to the coverage expansion, among the radio terminals PUE connected to the picocell base station PeNB. Note that the to-be-allocated radio-resource determining unit 224 can specify the radio terminal PUE with a deteriorated reception quality on the basis of the CQI fed back from each radio terminal PUE.

In step S23, the X2-interface communication unit 240 of the picocell base station PeNB transmits the information indicative of the bias value determined by the bias-value determining unit 223 and information indicative of the to-be-allocated radio resource determined by the to-be-allocated radio-resource determining unit 224 to the macrocell base station MeNB. Here, the information indicative of the to-be-allocated radio resource can be information in which whether a resource block is to be or not to be allocated is indicated for each resource block. For example, the information is formed of a bit string in which “1” is a resource block to be allocated while “0” is a resource block not to be allocated. The X2-interface communication unit 140 of the macrocell base station MeNB receives the information indicative of the bias value and the information indicative of the to-be-allocated radio resource.

In step S24, the storage 130 of the macrocell base station MeNB stores the information indicative of the bias value received by the X2-interface communication unit 140. The stored bias value will then be referred to by the connecting-destination selecting unit 121.

In step S25, the usable-resource determining unit 123 of the macrocell base station MeNB determines of the usable PDSCH resource of the macrocell base station MeNB on the basis of the information indicative of the to-be-allocated radio resource received by the X2-interface communication unit 140. Specifically, the usable-resource determining unit 123 determines the usable PDSCH resource of the macrocell base station MeNB in such a way as to avoid the resource blocks to be allocated to the radio terminal PUE having reception quality deteriorated due to the coverage expansion.

In step S26, the resource allocating unit 124 of the macrocell base station MeNB allocates a radio resource (resource blocks) to the radio terminal MUE out of the usable PDSCH resource determined by the usable-resource determining unit 123.

In step S27, the resource allocating unit 222 of the picocell base station PeNB allocates a radio resource (resource blocks) to the radio terminal PUE. In this step, the resource allocating unit 222 allocates the to-be-allocated radio resource determined by the to-be-allocated radio-resource determining unit 224 to the radio terminal PUE having reception quality deteriorated due to the coverage expansion.

As described above, the second embodiment can achieve the same advantageous effects as the first embodiment.

### Other Embodiments

As described above, the present invention has been described according to the embodiments. However, it should not be understood that the descriptions and drawings constituting a part of the present disclosure limit the present invention. Various alternative embodiments, examples, and operational techniques will be apparent for those skilled in the art from this disclosure.

While the macrocell base station MeNB determines the RE-basis bias value in the foregoing first embodiment, the configuration may be such that each picocell base station PeNB determines the RE-basis bias value and that the picocell base station PeNB notifies the macrocell base station MeNB of the determined bias value.

While each picocell base station PeNB determines the RE-basis bias value in the foregoing second embodiment, the configuration may be such that the macrocell base station MeNB determines the RE-basis bias value and that the macrocell base station MeNB notifies the picocell base station PeNB of the determined bias value.

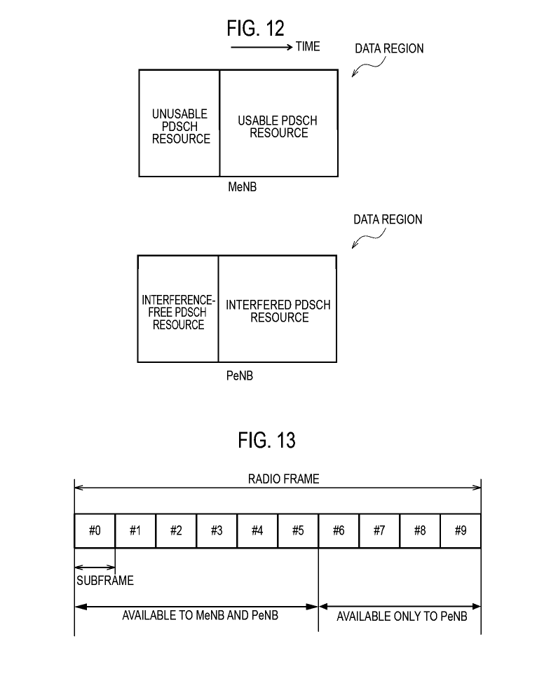

While each foregoing embodiment has described a case where a PDSCH resource is frequency-divided, the PDSCH resource may be time-divided. FIG. 12 is a diagram for describing the case of time-dividing the PDSCH resource. Although the proportion of the time division can be set in various ways, the division is done in units of OFDM symbols, in consideration of the specifications of LTE. Alternatively, instead of time-dividing a subframe in units of OFDM symbols, the radio frame shown in FIG. 2 may be time-divided in units of subframes. FIG. 13 shows the case of time-dividing the radio frame in units of subframes. In the case of time-dividing the radio frame in units of subframes, the radio frame is divided into subframes which only the picocell base station PeNB can use and subframes which both the macrocell base station MeNB and the picocell base station PeNB can use.

While each foregoing embodiment has described division of a PDSCH resource (i.e., division of a data region), the division is not limited to PDSCH and may be applied to division of a PDSCH resource (i.e., division of a control region). The division of a PDCCH resource can as well employ any of frequency division and time division.

Meanwhile, LTE Advanced is planned to employ a relay node which is a radio base station wirelessly forming a backhaul, and also is planned to employ an X2 interface for the relay node. Then, the relay node may be the low-power base station according to the present invention.

Further, while each foregoing embodiment has been described in connection with an LTE system, the present invention may be applied to other radio communication systems such as a radio communication system based on WiMAX (IEEE 802.16).

It should be understood that the present invention comprises various embodiments which are not described herein. Accordingly, the present invention is only limited by the scope of the claims and matters specifying the invention, which are appropriate from this disclosure.

Note that the entire content of Japanese Patent Application No. 2010-095547 (filed on Apr. 16, 2010) is incorporated in the present specification by reference.

### INDUSTRIAL APPLICABILITY

The a radio communication system, a high-power base station, a low-power base station, and a communication control method of the present invention are applicable to radio communication such as mobile communication, by which it is possible to avoid the interference between the radio base stations in the heterogeneous network, and thereby improve the throughput of the whole system.

1. A radio communication system comprising:
a high-power base station; and
a low-power base station placed within a communication area of the high-power base station and having transmission output lower than the high-power base station,
the radio communication system further comprising:
a determining unit configured to determine a usable resource being a radio resource which the high-power base station is allowed to use as a particular downlink channel; and
an allocating unit configured to allocate a radio resource to a radio terminal connected to the high-power base station, out of the usable resource determined by the determining unit, wherein
the determining unit determines the usable resource in a case of expanding coverage of the low-power base station.

2. The radio communication system according to claim 1, wherein the determining unit determines the usable resource in such away that the usable resource decreases as a degree of the expansion of the coverage of the low-power base station increases.

3. The radio communication system according to claim 1, wherein the determining unit determines the usable resource in such a way that when the coverage of the low-power base station is expanded, the usable resource is smaller than the usable resource before the expansion of the coverage of the low-power base station.

4. The radio communication system according to claim 1, wherein the determining unit determines the usable resource in such a way as to avoid a radio resource that is to be allocated to a radio terminal having reception quality deteriorated due to the coverage expansion, among radio terminals connected to the low-power base station.

5. The radio communication system according to claim 1, further comprising a selecting unit configured to select a base station with the highest reception quality value as a connecting destination of a radio terminal, on the basis of: a first reception quality value indicative of a reception quality of a radio signal which the radio terminal receives from the high-power base station; a second reception quality value indicative of the reception quality of a radio signal which the radio terminal receives from the low-power base station; and a correction value for correcting the second reception quality value to a higher value, wherein
the correction value is indicative of a degree of the expansion of the coverage of the low-power base station, and
the determining unit determines the usable resource on the basis of the correction value.

6. The radio communication system according to claim 1, wherein the particular downlink channel is a data transmission channel for transmitting user data to a radio terminal.

7. The radio communication system according to claim 1, wherein the usable resource is a frequency band being at least part of an entire frequency band of a downlink.

8. The radio communication system according to claim 1, wherein the usable resource is a time range being at least part of a communication time frame of a downlink.

9. A high-power base station comprising:
a determining unit configured to determine a usable resource being a radio resource which the high-power base station is allowed to use as a particular downlink channel, on the basis of a degree of expansion of coverage of a low-power base station placed within a communication area of the high-power base station and having transmission output lower than the high-power base station; and
an allocating unit configured to allocate a radio resource to a radio terminal connected to the high-power base station, out of the usable resource determined by the determining unit.

10. A low-power base station placed within a communication area of a high-power base station and having transmission output lower than the high-power base station, comprising:
a to-be-allocated radio-resource determining unit configured to, in a case of expanding coverage of the low-power base station, determine a radio resource that is to be allocated to a radio terminal having reception quality deteriorated due to the coverage expansion, among radio terminals connected to the low-power base station; and
a transmitter configured to transmit information indicative of the to-be-allocated radio resource determined by the to-be-allocated radio-resource determining unit to the high-power base station.

11. A communication control method comprising the steps of:
determining a usable resource being a radio resource which a high-power base station is allowed to use as a particular downlink channel, on the basis of a degree of expansion of coverage of a low-power base station placed within a communication area of the high-power base station and having transmission output lower than the high-power base station; and
allocating a radio resource to a radio terminal connected to the high-power base station, out of the usable resource determined in the determining step.

12. A communication control method comprising the steps of:
in a case of expanding coverage of a low-power base station placed within a communication area of a high-power base station and having transmission output lower than the high-power base station, determining a radio resource that is to be allocated to a radio terminal having reception quality deteriorated due to the coverage expansion, among radio terminals connected to the low-power base station; and
transmitting information indicative of the to-be-allocated radio resource determined in the determining step from the low-power base station to the high-power base station.

13. A communication control method comprising the steps of:
determining a usable resource being a radio resource which a high-power base station is allowed to use as a particular downlink channel, on the basis of a degree of expansion of coverage of a low-power base station placed within a communication area of the high-power base station and having transmission output lower than the high-power base station; and
transmitting information indicative of the usable resource determined in the determining step from the high-power base station to the low-power base station.
